(19) United States
(12) Patent Application Publication
(10) Pub. No.: US 2013/0335360 A1
(43) Pub. Date: Dec. 19, 2013

(54) TOUCH SCREEN INTERACTION METHODS AND APPARATUSES

(71) Applicants: Aviv Ron, Nir Moshe (IL); Mickey Shkatov, Bat Yam (IL); Vasily Sevryugin, Nizhny Novgorod (IL)

(72) Inventors: Aviv Ron, Nir Moshe (IL); Mickey Shkatov, Bat Yam (IL); Vasily Sevryugin, Nizhny Novgorod (IL)

(21) Appl. No.: 13/995,933

(22) PCT Filed: Jan. 3, 2012
(86) PCT No.: PCT/US12/20025

§ 371 Date: Sep. 6, 2013

(51) Int. Cl. G06F 3/041

(52) U.S. Cl. CPC G06F 3/041
USPC 345/173

(57) ABSTRACT

Methods, apparatuses and storage medium associated with touch screen interaction are disclosed herein. In various embodiments, a method may include detecting, by a device, such as a mobile device, an about to occur interaction with an area of a touch sensitive display of the device; and providing, by the device, in response to a detection, assistance for the detected about to occur interaction. In various embodiments, providing assistance may include zooming in on the area of a detected about to occur interaction, or displaying a visual aid in the area of a detected about to occur interaction. Other embodiments may be disclosed or claimed.

### RELATED APPLICATIONS

This application is related to U.S. Patent Application <to be assigned> (attorney client reference ITL2517wo), entitled “Facilitating The User of Selectable Elements on Touch Screens,” contemporaneously filed.

### TECHNICAL FIELD

This application relates to the technical fields of data processing, more specifically to methods, apparatuses and storage medium associated with touch screen interaction.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Recent advances in computing, networking and related technologies have led to rapid adoption of mobile computing devices (hereinafter, simply mobile devices), such as personal digital assistants, smart phones, tablet computers, and so forth. Increasingly, mobile devices may include touch sensitive displays (also referred to as touch sensitive screens) that are configured for displaying information, as well as for obtaining user inputs through screen touches by the users. Compared to displays of conventional computing devices, such as desktop computers or laptop computers, touch sensitive screens typically have smaller display areas. Thus, often it is more difficult for users to interact with the displayed information, especially for the visually challenged users.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 is a block diagram illustrating a method for facilitating touch screen interactions;

FIGS. 2 and 3 illustrate a pair of external views of an example device, further illustrating the method of FIG. 1;

FIGS. 4 and 5 illustrate another pair of external views of another example device, further illustrating the method of FIG. 1;

FIG. 6 illustrates an example architectural view of the example devices of FIGS. 2-5;

FIG. 7 illustrates an example non-transitory computer-readable storage medium having instructions configured to practice all or selected aspects of the method of FIG. 1; and

FIG. 8 illustrates an example computing system suitable for use as a device to practice the method of FIG. 1; all arranged in accordance with embodiments of the present disclosure.

### DETAILED DESCRIPTION

Methods, apparatuses and storage medium associated with touch screen interaction are disclosed herein. In various embodiments, a method may include detecting, by a device, such as a mobile device, an about to occur interaction with an area of a touch sensitive display of the device; and providing, by the device, in response to a detection, assistance for the detected about to occur interaction.

In various embodiments, providing assistance may include zooming in on the area of a detected about to occur interaction, or displaying a visual aid in the area of a detected about to occur interaction. In various embodiments, displaying a visual aid may include displaying one or more images that depict one or more undulations in the area of the detected about to occur interaction.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

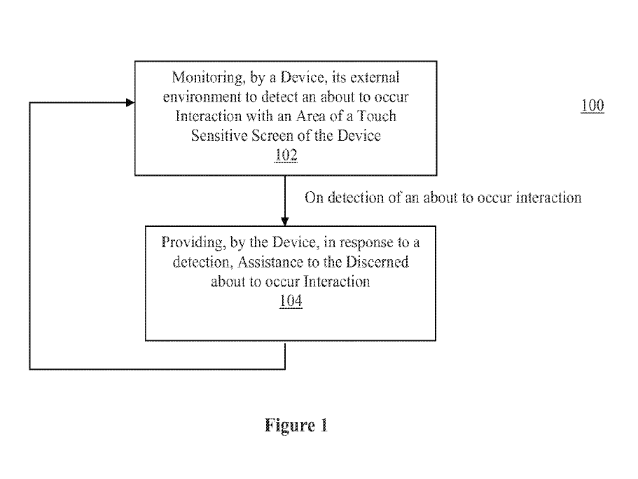

Referring to FIG. 1, wherein a method for facilitating touch screen interaction, in accordance with various embodiments of the present disclosure, is illustrated. As shown, method 100 may begin at block 102, wherein a device, such as a mobile device, may monitor its external environment to detect an about to occur interaction with an area of a touch sensitive display of the device. From block 102, on detection of an about to occur interaction, method 100 may transition to block 104, wherein the device may provide assistance for the detected about to occur interaction. From block 104, on provision of the assistance, method 100 may return to block 102, and continues operation as earlier described.

In various embodiments, the mobile device may be a personal digital assistant, a smart phone, or a tablet computer. In other embodiments, the device may be a desktop computer or a laptop computer.

In various embodiments, a device may monitor its external environment to detect an about to occur interaction by continually analyzing images of its external environment, e.g., images of the space in front of the device, to detect hand and/or finger movements of a user of the device. In various embodiments, an about to occur interaction with an area may be considered detected when a user finger is within a predetermined distance from the area. The predetermined distance may vary from implementation to implementation, and preferably, may be customized for different devices and/or users. In various embodiments, the device may include one or more cameras configured to capture images of its external environment, e.g., images of the space in front of the device.

In various embodiments, on detection of an about to occur interaction, a device may provide assistance by zooming in on the area of a detected about to occur interaction. In other embodiments, the device may display a visual aid in the area of a detected about to occur interaction. In various embodiments, the displayed visual aid may include one or more images that depict one or more undulations in the area of the detected about to occur interaction.

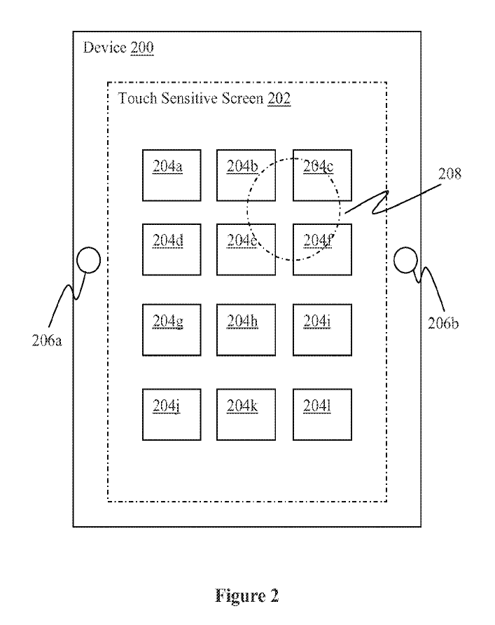

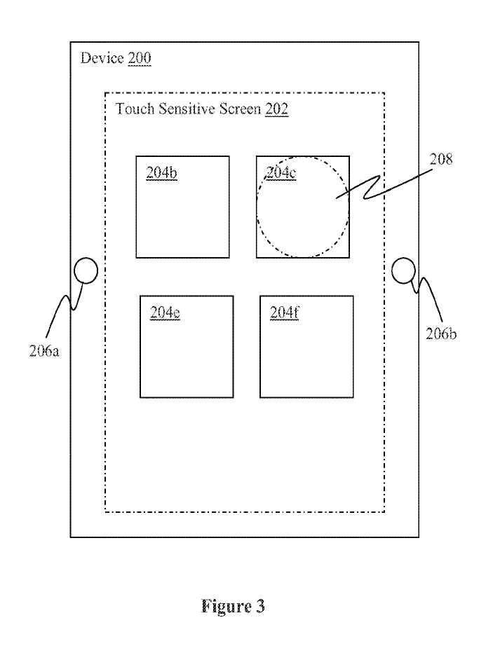

Referring now to FIGS. 2 and 3, wherein a pair of external views of a device further illustrating the method of FIG. 1, in accordance with embodiments of the present disclosure, is shown. As depicted, device 200 may include touch sensitive screen 202, and one or more front facing cameras 206a-206b. During operation, various information, e.g., icons 204a-204l, may be displayed on touch sensitive screen 202, e.g. by applications operating on device 200 or by an operating system of device 200 (via e.g., a device driver associated with touch sensitive screen 202). Further, cameras 206a-206b may periodically or continually capture images of the space in front of device 200. The captured images may be provided to an input driver of device 200, e.g., the device driver associated with touch sensitive screen 202. The input driver may analyze the images for hand and/or finger movements of a user of device 200 to detect an about to occur interaction with an area of touch sensitive screen 202, e.g., area 208. In response to the detection, the input driver may cause device 200 to zoom in on the information displayed in the area, as illustrated in FIG. 3. In various embodiments, the zooming in may be variable and/or adaptive in speed, reflective of whether the user appears to continue to approach the area. Accordingly, touch screen interactions may be more user friendly, especially for visually challenged users.

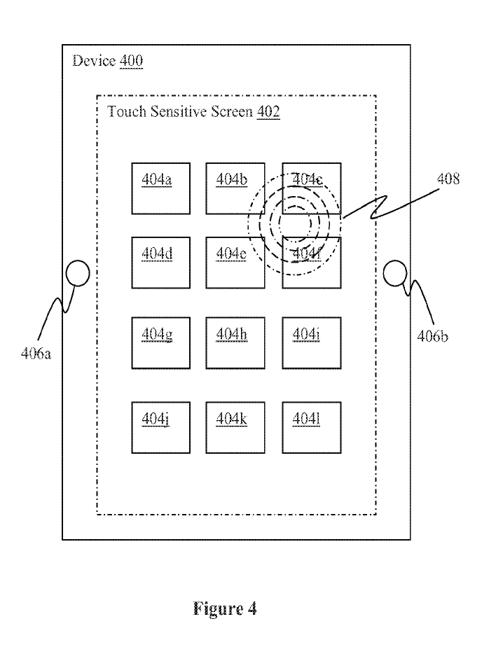

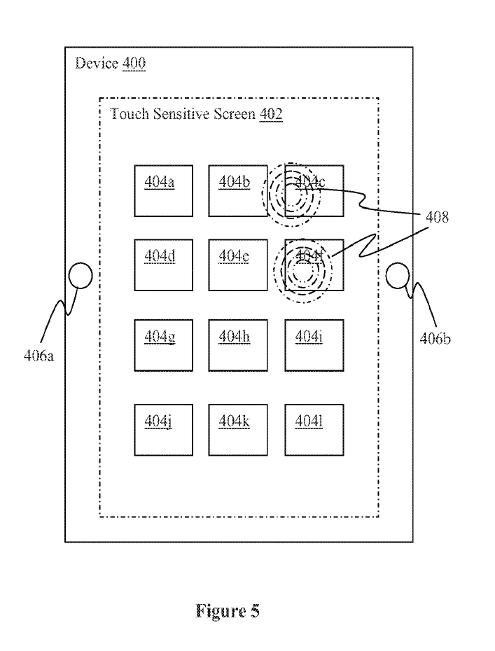

Referring now to FIGS. 4 and 5, wherein another pair of external views of a device further illustrating the method of FIG. 1, in accordance with embodiments of the present disclosure, is shown. As depicted, device 400 may similarly include touch sensitive screen 402, and one or more front facing cameras 406a-406b. During operation, various information, e.g., icons 404a-404l, may be displayed on touch sensitive screen 402, e.g., by applications operating on device 400 or by an operating system of device 400 (via, e.g., a device driver associated with touch sensitive screen 402). Further, cameras 406a-406b may periodically or continually capture images of the space in front of device 400. The captured images may be provided to an input driver of device 400, e.g., the device driver associated with touch sensitive screen 402. The input driver may analyze the images for hand and/or finger movements of a user of device 400 to detect an about to occur interaction with an area of touch sensitive screen 402. In response to the detection, the input driver may cause device 400 to display one or more visual aids 408 to assist the user, confirming for the user the area or areas of touch sensitive screen 402 the user's finger or fingers are moving towards. In various embodiments, visual aid may include a series of images depicting a series of undulations, conveying e.g., water ripples. In various embodiments the rate of undulations may be variable and/or adaptive, reflective of whether the user appears to continue to approach the area. Further, in various embodiments, two series of undulations may be displayed to correspond to apparent target areas of two fingers of the user, e.g., for a greater area encompassing the apparent target areas currently having displays of an application that supports enlargement or reduction of an image through two finger gestures of the user. Accordingly, touch screen interactions may also be more user friendly, especially for visually challenged users.

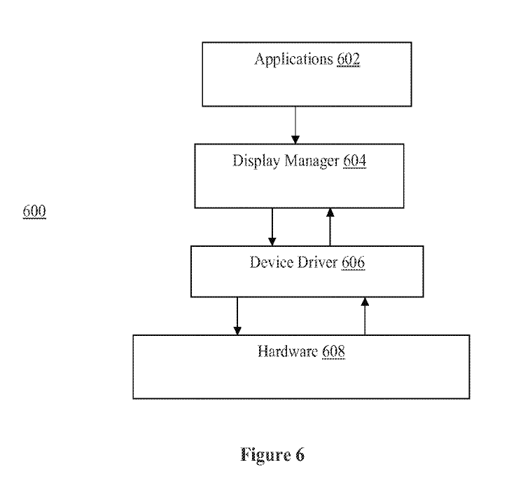

Referring now to FIG. 6, wherein an architectural view of the devices of FIGS. 2-5, in accordance with various embodiments of the present disclosure, is shown. As illustrated, architecture 600 of devices 200/400 may include various hardware elements 608, e.g., earlier described touch sensitive screens 202/402, and cameras 206a-206b/406a-406b. Associated with hardware elements 608 may be one or more device drivers 606, e.g., one or more device drivers associated with touch sensitive screens 202/402, and cameras 206a-206b/406a-406b. Architecture 600 of devices 200/400 may also include display manager 604, configured to display information on touch sensitive screens 202/402, via more device drivers 606, for applications 602.

For the embodiments, the device driver 606 associated with cameras 206a-206b/406a-406b may be configured to control cameras 206a-206b/406a-406b to periodically/continually capture images of the external environment of device 200/400. In various embodiments, the device driver 606 may be further configured to analyze the images for hand and/or finger movements of the user, or provide the images to another device driver 606, e.g., the device driver 606 associated with touch sensitive screens 202/402 to analyze the images for hand and/or finger movements of the user.

Additionally, for the embodiments of FIGS. 2-3, the monitoring/analyzing device driver 606 may be configured to notify display manager 604 to zoom in on the information displayed in the area, on detection of an about to occur interaction, e.g., on detection of a user finger within a predetermined distance from an area of touch sensitive screens 202/402. Further, for the embodiments of FIGS. 4-5, the monitoring/analyzing device driver 606 may be configured to display (or cause another device driver 606) to display one or more visual aids.

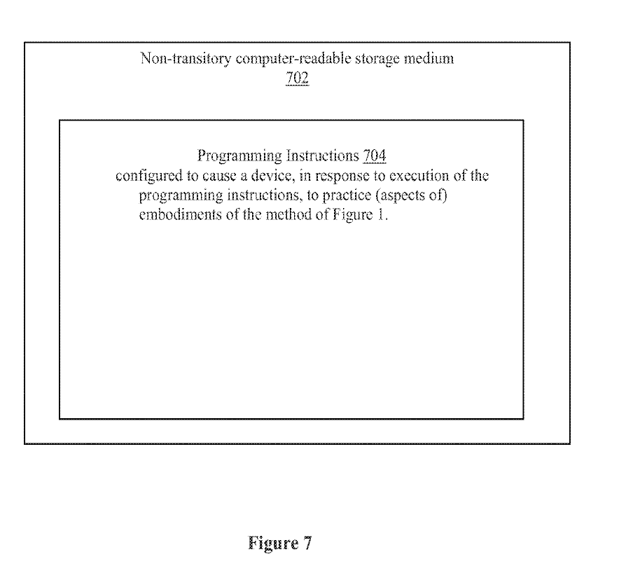

FIG. 7 illustrates a computer-readable storage medium, in accordance with various embodiments of the present disclosure. As illustrated, computer-readable storage medium 702 may include a number of programming instructions 704. Programming instructions 704 may be configured to enable a device 200/400, in response to execution of the programming instructions, to perform operations of method 100 earlier described with references to FIG. 1. In alternate embodiments, programming instructions 704 may be disposed on multiple computer-readable storage media 702 instead. In various embodiments, computer-readable storage medium 702 may be non-transitory computer-readable storage medium, such as compact disc (CD), digital video disc (DVD), Flash, and so forth.

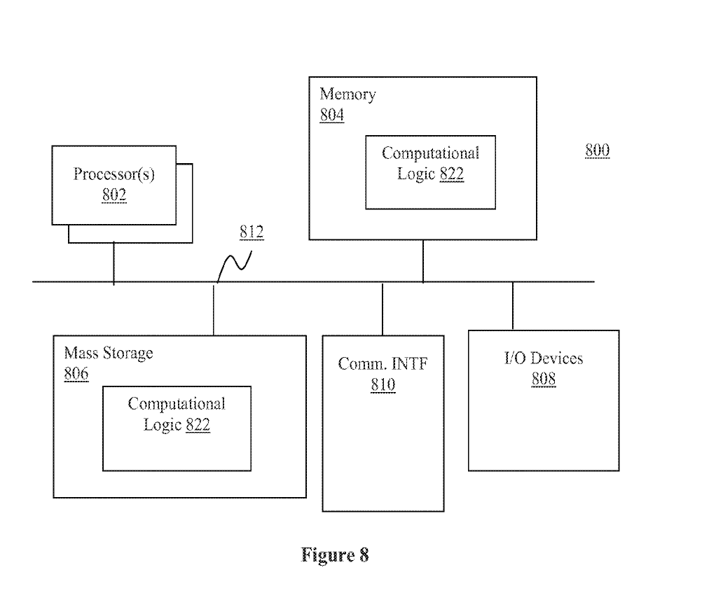

FIG. 8 illustrates an example computer system suitable for use as device 200/400 in accordance with various embodiments of the present disclosure. As shown, computing system 800 includes a number of processors or processor cores 802, and system memory 804. For the purpose of this application, including the claims, the terms “processor” and “processor cores” may be considered synonymous, unless the context clearly requires otherwise. Additionally, computing system 800 includes mass storage devices 806 (such as diskette, hard drive, compact disc read only memory (CD-ROM) and so forth), input/output (I/O) devices 808 (such as touch sensitive screens 202/402, cameras 206a-206b/406a/406b, and so forth) and communication interfaces 810 (such as, WiFi, Bluetooth, 3G/4G network interface cards, modems and so forth). The elements may be coupled to each other via system bus 812, which represents one or more buses. In the case of multiple buses, the multiple buses may be bridged by one or more bus bridges (not shown).

Each of these elements may be configured to perform its conventional functions known in the art. In particular, system memory 804 and mass storage 806 may be employed to store a working copy and a permanent copy of the programming instructions configured to perform operations of method 100 earlier described with references to FIG. 1, herein collectively denoted as, computational logic 822. Computational logic 822 may further include programming instructions to provide other functions, e.g., various device driver functions. The various components may be implemented by assembler instructions supported by processor(s) 802 or high-level languages, such as, e.g., C, that can be compiled into such instructions.

The permanent copy of the programming instructions may be placed into mass storage 806 in the factory, or in the field, through, e.g., a distribution medium (not shown), such as a compact disc (CD), or through communication interface 810 (from a distribution server (not shown)). That is, one or more distribution media having an implementation of computational logic 822 may be employed to distribute computational logic 822 to program various computing devices.

For one embodiment, at least one of the processor(s) 802 may be packaged together with computational logic 822. For one embodiment, at least one of the processor(s) 802 may be packaged together with computational logic 822 to form a System in Package (SiP). For one embodiment, at least one of the processor(s) 802 may be integrated on the same die with computational logic 822. For one embodiment, at least one of the processor(s) 802 may be integrated on the same die with computational logic 822 to form a System on Chip (SoC). For at least one embodiment, the SoC may be utilized in a smart phone, cell phone, tablet, or other mobile device.

Otherwise, the constitution of the depicted elements 802-812 are known, and accordingly will not be further described. In various embodiments, system 800 may have more or less components, and/or different architectures.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims and the equivalents thereof.

1. At least one non-transitory computer-readable storage medium having a plurality of instructions configured to enable a device having a touch sensitive display, in response to execution of the instructions by the device, to:
monitor the device to detect for an about to occur interaction with an area of the touch sensitive display; and
in response to a detection, provide assistance for the detected about to occur interaction.

2. The at least one computer-readable storage medium of claim 1, wherein the instructions are configured to enable the device, in response to execution of the instructions by the device, to process image data captured by one or more cameras of the device to detect an about to occur interaction with an area of the touch sensitive display.

3. The at least one computer-readable storage medium of claim 2, wherein the instructions are configured to enable the device, in response to execution of the instructions by the device, to process image data captured by one or more cameras of the device to detect finger movements of a user of the device.

4. The at least one computer-readable storage medium of claim 1, wherein the instructions are configured to enable the device, in response to execution of the instructions by the device, to cause the device to zoom in on the area of a detected about to occur interaction, in response to the detection.

5. The at least one computer-readable storage medium of claim 4, wherein the instructions are configured to enable the device, in response to execution of the instructions by the device, to cause a notification to be sent to a display manager of the device to zoom in on the area of the detected about to occur interaction.

6. The at least one computer-readable storage medium of claim 1, wherein the instructions are configured to enable the device, in response to execution of the instructions by the device, to cause the device to display a visual aid in the area of a detected about to occur interaction, in response to the detection.

7. The at least one computer-readable storage medium of claim 6, wherein the instructions are configured to enable the device, in response to execution of the instructions by the device, to cause a display driver of the device to display a visual aid comprising one or more images that depict one or more undulations in the area of the detected about to occur interaction.

8. The at least one computer-readable storage medium of claim 1, wherein the device is a mobile device.

9. A method comprising:
detecting, by a device, an about to occur interaction with an area of a touch sensitive display of the device; and
providing, by the device, in response to a detection, assistance for the detected about to occur interaction.

10. The method of claim 9, wherein detecting comprises processing image data captured by one or more cameras of the device.

11. The method of claim 10, processing comprises processing the image data to detect finger movements of a user of the device.

12. The method of claim 9, wherein providing comprises zooming in on the area of a detected about to occur interaction.

13. The method of claim 12, wherein providing comprises notifying a display manager of the device to zoom in on the area of the detected about to occur interaction.

14. The method of claim 9, wherein providing comprises displaying a visual aid in the area of a detected about to occur interaction.

15. The method of claim 14, wherein displaying comprises displaying a visual aid that includes one or more images that depict one or more undulations in the area of the detected about to occur interaction.

16. The method of claim 9, wherein the device is a mobile device.

17. An apparatus comprising:
one or more processors;
a display unit coupled with the one or more processors, wherein the display unit includes a touch sensitive screen; and
a display driver configured to be operated by the one or more processors to detect an about to occur interaction with an area of the touch sensitive screen, and to provide or cause to provide, in response to a detection, assistance for the detected about to occur interaction.

18. The apparatus of claim 17, further comprises one or more cameras;
wherein the display driver is configured to process image data captured by the one or more cameras to detect an about to occur interaction with the touch sensitive screen.

19. The apparatus of claim 18, wherein the display driver is configured to process the image data to detect finger movements of a user of the apparatus.

20. The apparatus of claim 17, further comprising a display manager configured to be operated by the one or more processors to display images on the display unit;
wherein the display driver is configured to cause the display manager, in response to a detection, to zoom in on the area of a detected about to occur interaction.

21. The apparatus of claim 20, wherein the display driver is configured to notify the display manager, in response to a detection, to zoom in on the area of the detected about to occur interaction.

22. The apparatus of claim 17, wherein the display driver is configured to display, in response to a detection, a visual aid in the area of a detected about to occur interaction.

23. The apparatus of claim 22, wherein the display driver is configured to display, in response to a detection, a visual aid that includes one or more images that depict one or more undulations in the area of the detected about to occur interaction.

24. The apparatus of claim 17, wherein the apparatus is a selected one of a smart phone or a computing tablet.

25. An apparatus comprising:
one or more processors;
a plurality of front facing cameras coupled with the one or more processors;
a display unit coupled with the one or more processors, including a touch sensitive screen;
a display manager configured to be operated by the one or more processors to display images on the display unit; and
a display driver configured to be operated by the one or more processors to process image data captured by the one or more front facing cameras, to detect finger movements of a user of the apparatus, to identify an about to occur interaction with an area of the touch sensitive screen, and to provide or cause to provide, in response to a detection, assistance for the detected about to occur interaction.
